(19) United States
(12) Patent Application Publication
(10) Pub. No.: US 2009/0320934 A1
(43) Pub. Date: Dec. 31, 2009

(54) Intake-Gas Throttle Device

(76) Inventors: Willi Parsch, Seeheim (DE); Tito Schaefer, Daubach (DE)

Correspondence Address: Davidson, Davidson & Kappel, LLC, 485 7th Avenue, 14th Floor, New York, NY, 10018, US

(21) Appl. No.: 12/084,535

(22) PCT Filed: Oct. 20, 2006
(86) PCT No.: PCT/DE2006/001849

§ 371 Date: May 15, 2009

(30) Foreign Application Priority Data
Nov. 9, 2005 (DE) 102005053453.8

(51) Int. Cl. F16K 31/12

(52) U.S. Cl. 137/485

(57) ABSTRACT

An intake-gas throttle device in the intake pressure region of an air-conditioning compressor, in particular for air-conditioning systems of motor vehicles, the device controlling the delivery rate of the air-conditioning compressor.

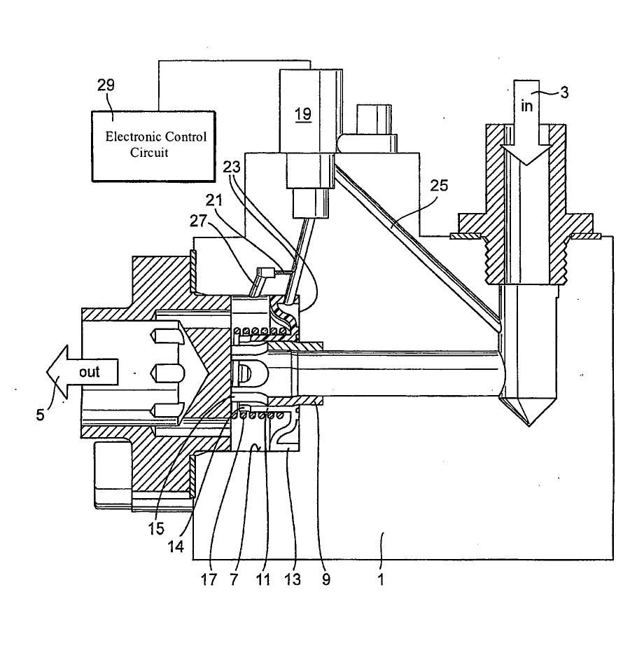

The present invention relates to a suction-gas throttle device in the suction zone of an air-conditioning compressor, in particular for air-conditioning systems of motor vehicles, the device controlling the delivery rate of the air-conditioning compressor.

### BACKGROUND

Suction-gas throttle devices of this kind are generally known. In these devices, automatic throttling of the suction gas can be effectively accomplished only by means of an on-off controller, and volume flow control is possible only by internal control, such as in the case of internally controlled variable displacement compressors. This type of control still requires the use of an additional clutch for the compressor.

### SUMMARY OF THE INVENTION

In view of the above, it is an object of the present invention to provide an external volume flow control device for a suction throttling system which operates completely independently of the volume flows and pressures prevailing in the system. In particular, the adjustment should be simple from a mechanical point of view.

The present invention provides a suction-gas throttle device in the suction pressure zone of an air-conditioning compressor, in particular for air-conditioning systems of motor vehicles, the device controlling the delivery rate of the air-conditioning compressor and being provided with a pilot device.

A suction-gas throttle device is preferred in which the pilot device controls a variable cross-sectional area of the throttle, for example, by means of a slide valve provided in the suction flow zone of the air-conditioning compressor. Also preferred is a suction-gas throttle device in which one side of the slide valve is connected to a pilot pressure chamber, and the other side of the slide valve is connected to the pressure zone in the suction flow zone of the air-conditioning compressor that is located downstream of the suction-gas throttle device.

In accordance with a preferred embodiment of the present invention, the pilot pressure chamber may be connected via an inflow resistance to the suction flow zone upstream of the suction-gas throttle device, and via an outflow resistance to the suction flow zone downstream of the suction-gas throttle device, or vice versa.

In a preferred embodiment of the present invention of a suction-gas throttle device, the inflow resistance is in the form of a valve. Also preferred is a suction-gas throttle device in which the valve is actuated by solenoid in a pulse-width modulated manner.

Moreover, a suction-gas throttle device is preferred in which the outflow resistance of the pilot pressure chamber is a constant flow resistance provided, for example, by a restrictor.

In another preferred embodiment of a suction-gas throttle device according to the present invention, the slide valve is movable against a spring force and the pressure from the pilot pressure chamber that prevails downstream of the suction-gas throttle device, so that the main cross-sectional area of the throttle can be continuously reduced by moving the slide valve.

Also preferred is a suction-gas throttle device in which the pulse-width modulation pulsation of the pilot valve may be attenuated by the volume in the pilot pressure chamber, so that an approximately constant pilot pressure which may be proportional to the pulse-width modulation signal may be built up in the pilot pressure chamber, and the slide valve may not pulsate, but may assumes a proportional valve position. This has the advantages that, because of the attenuating properties of the gas-filled pilot pressure chamber and its dimensioning for piloting purposes, it is possible to use a pulse-width modulated valve, while nevertheless the main stage, for example, the slide valve, may assumes a non-pulsating position which may be proportional to the pulse width.

Furthermore, a suction-gas throttle device is preferred in which the slide valve may be disposed between the suction pressure zone of the air-conditioning system and the suction pressure zone of the compressor. Also preferred is a suction-gas throttle device in which the inflow valve of the pilot device may be disposed between the suction pressure zone of the air-conditioning system and the pilot pressure chamber. Moreover, a suction-gas throttle device is preferred in which the outflow resistance of the pilot device may be disposed between the pilot pressure chamber and the suction pressure zone of the air-conditioning compressor.

In one embodiment of the suction-gas throttle device according to the present invention, the slide valve may be in the form of a diaphragm slide valve. In another embodiment of the suction-gas throttle device according to the present invention, the slide valve may be in the form of a piston slide valve. Also preferred is a suction-gas throttle device in which a sliding sleeve may have openings which, together with openings provided in a guide sleeve, form a throttling point for the suction flow of the air-conditioning compressor.

### BRIEF DESCRIPTION OF THE DRAWINGS

The present invention will now be described with reference to the FIGURE.

The single FIGURE shows a piloted suction-gas throttle device.

### DETAILED DESCRIPTION

A housing 1 has an inlet in communication with the suction zone 3 of an air-conditioning system, and an outlet in communication with the suction zone 5 of an air-conditioning compressor. An opening 7 in housing 1 has permanently disposed therein a guide sleeve 9 on which is slidably mounted a sliding sleeve 11 having a diaphragm 13. Sliding sleeve 11 has approximately semicircular openings 14, and guide sleeve 9 has corresponding larger openings 15, so that when the sliding sleeve is advanced, the total cross-sectional area of the throttle, which is defined by the overlap of openings 14 and 15, throttles the suction flow passing through the suction-gas throttle device to the compressor. Sliding sleeve 11, which is integrally connected to diaphragm 13, is pressed against its rear stop by a coil spring 17.

Housing 1 further has a pilot device for this slide valve device, said pilot device substantially including a pulse-width modulated valve 19, an outflow resistance 21, here in the form of a constriction, for example, a restrictor, and a pilot pressure chamber 23 formed by the conduit volume between valve 19 and resistance 21 and by the volume of the pressure chamber behind diaphragm 13. Suction pressure zone 3, which is in communication with the air-conditioning system, is connected by an inflow conduit 25 to pilot valve 19, and an outflow conduit 27 leads from outflow restrictor 21 to the suction pressure zone downstream of the suction-gas throttle device, for example, to the suction pressure zone 5 of the air-conditioning compressor.

The operation of the pilot device is described as follows. When pulse-width modulated valve 19 is closed, for example, by an external electronic control circuit 29, the connection to suction pressure zone 3 of the air-conditioning system is interrupted. Pilot pressure zone 23 is in communication with the suction pressure of the air-conditioning compressor in zone 5 via pilot outflow conduit 27 and restrictor 21, so that the pressures in front of and behind diaphragm 13 are the same. Consequently, coil spring 17 holds sliding sleeve 11 and its openings 14 in the position shown; providing maximum open area for flow through the suction-gas throttle device. When valve 19 is now opened for increasingly greater time periods by an increasing pulse-width modulated signal, the gas flowing from suction pressure zone 3 through pilot line 25 into pilot pressure chamber 23 causes a pressure to build up therein at an increasingly higher rate than in zone 5 downstream of the suction-gas throttle device. This is because the outflow of gas from pilot pressure chamber 23 is retarded by restrictor 21, and because said outflow may occur at a rate which may be slower than the rate at which gas flows from the slightly higher suction pressure in zone 3 through conduit 25 into pilot pressure chamber 23. Thus, the pilot pressure behind diaphragm 13 increases and moves diaphragm 13, and thus sliding sleeve 11, against the force of spring 17 and against the suction pressure in zone 5, thereby reducing the cross-sectional opening area provided by the overlapping openings 15 of guide sleeve 9 and 13 of sliding sleeve 11. Since the medium in pilot pressure chamber 23 is a gas, the pulsations of valve 19 are attenuated in this gas volume and are not imparted to the movement of sliding sleeve 11, so that, in spite of the pulse-width modulated signal of pilot valve 19, the cross-sectional area of the throttle can be adjusted to a constant non-pulsating position which is proportional to the signal. This has not been possible in the known prior art. Thus, the pilot control system provided in accordance with the present invention allows adjustment of a smooth, for example, constant, main throttle setting using a pulse-width modulated, for example, oscillating, input signal, the throttle setting being proportional to the pulse width and used for controlling the suction volume flow of an air-conditioning compressor.

### LIST OF REFERENCE NUMERALS

1 housing
3 inlet
5 outlet
7 opening
9 guide sleeve
11 sliding sleeve
13 diaphragm
14 semicircular openings
15 openings
17 coil spring
21 outflow resistance
23 pilot pressure chamber
25 inflow conduit
27 outflow conduit
29 electronic control circuit

1-14. (canceled)

15. A suction-gas throttle device in the suction pressure zone of an air-conditioning compressor the suction gas throttle device controlling the delivery rate of the air-conditioning compressor, the suction-gas throttle device comprising:
a pilot device.

16. The suction gas throttle device as recited in claim 15 wherein the suction gas throttle device is for an air conditioning system of a motor vehicle.

17. The suction-gas throttle device as recited in claim 15 wherein the pilot device controls a variable cross-sectional area of the throttle.

18. The suction gas throttle device as recited in claim 17 wherein the pilot device controls the variable cross-sectional areas of the throttle by a slide valve in the flow zone of an air conditioning compressor.

19. The suction-gas throttle device as recited in claim 17 wherein one side of the slide valve connects to a pilot pressure chamber, while the other side of the slide valve connects to an outlet suction flow zone in the an air-conditioning compressor located downstream of the suction-gas throttle device.

20. The suction-gas throttle device as recited in claim 19 wherein the pilot pressure chamber is connected via an inflow resistance to a suction flow zone upstream of the suction-gas throttle device, and via an outflow resistance to the outlet suction flow zone downstream of the suction-gas throttle device, or vice versa.

21. The suction-gas throttle device as recited in claim 20 wherein the inflow resistance is a valve.

22. The suction-gas throttle device as recited in claim 21 wherein the valve is actuated by a solenoid in a pulse-width modulated manner.

23. The suction-gas throttle device as recited in claim 20 wherein the outflow resistance is a constant flow resistance.

24. The suction gas throttle device as recited in claim 23 wherein the constant flow resistance is provided by a restrictor.

25. The suction-gas throttle device as recited in claim 18 wherein the slide valve is movable against a spring force and a pressure from the pilot pressure chamber prevailing downstream of the suction-gas throttle device, so that the main cross-sectional area of the suction gas throttle device can be continuously reduced by moving the slide valve.

26. The suction-gas throttle device as recited in claim 22 wherein the pulse-width modulation pulsation of the valve is attenuated by the volume in the pilot pressure chamber, the pilot pressure chamber building a constant pilot pressure proportional to the pulse-width modulation signal, the slide valve not pulsating, but assuming proportional valve position.

27. The suction-gas throttle device as recited in claim 20 wherein the slide valve is between the inlet suction flow zone- of the air-conditioning system and the outlet suction flow zone of the compressor.

28. The suction-gas throttle device as recited in claim 21 wherein the valve of the pilot device is between the inlet suction flow zone of the air-conditioning system and the pilot pressure chamber.

29. The suction-gas throttle device as recited in claim 23 wherein the outflow resistance of the pilot device is between the pilot pressure chamber and the outlet suction flow zone of the compressor.

30. The suction-gas throttle device as recited in claim 18 wherein the slide valve is a diaphragm slide valve.

31. The suction-gas throttle device as recited in claim 18 wherein the slide valve is a piston slide valve.
